(19) United States
(12) Patent Application Publication
(10) Pub. No.: US 2004/0247521 A1
(43) Pub. Date: Dec. 9, 2004

(54) Reversible storage of hydrogen using doped alkali metal aluminum hydrides

(76) Inventors: Borislav Bogdanovic, Mulheim an der Ruhr (DE); Michael Felderhoff, Essen (DE); Stefan Kaskel, Dresden (DE); Andre Pommerin, Oberhausen (DE); Klaus Schlichte, Mulheim an der Ruhr (DE); Ferdi Schuth, Mulheim an der Ruhr (DE)

Correspondence Address: NORRIS, MCLAUGHLIN & MARCUS, PA, 875 THIRD STREET, 18TH FLOOR, NEW YORK, NY, 10022, US

(21) Appl. No.: 10/499,526

(22) PCT Filed: Dec. 17, 2002
(86) PCT No.: PCT/EP02/14383

(30) Foreign Application Priority Data
Dec. 21, 2001 (DE) 10163697.0

(51) Int. Cl. C01B 6/24

(52) U.S. Cl. 423/644

(57) ABSTRACT

The invention relates to improved materials for reversibly storing hydrogen using alkali metal aluminum hydrides (alkali metal alanates) or mixtures of aluminum metal with alkali metal (hydride)s by doping these materials with catalysts having a high degree of dispersion or a large specific surface.

The present invention relates to improved materials for the reversible storage of hydrogen by means of alkali metal aluminum hydrides (alkali metal alanates) or mixtures of aluminum metal with alkali metal (hydride)s by doping these materials with catalysts which are very finely divided or have a large specific surface area.

The patent application of the Studiengesellschaft Kohle mbH (SGK) PCT/WO 97/03919 discloses a method of reversibly storing hydrogen using alkali metal alanates of the general formula M¹ₚ₍₁₋ₓ₎⁻M²ₚₓAlH₃₊ₚM¹=Na, K.; M²=Li, K.; 0≦x≦˜0.8; 1≦p≦3 as storage materials. To improve the hydrogenation/dehydrogenation kinetics, the alkali metal alanates are doped with transition metal compounds and rare earth metal compounds or combinations thereof in catalytic amounts. Particular preference is given to using the alanates NaAlH₄, Na₃AlH₆ and Na₂LiAlH₆.

Furthermore, a method of the SGK for reversibly storing hydrogen is known from PCT/EP01/02363, according to which mixtures of aluminum metal with alkali metals and/or alkali metal hydrides and transition metal and/or rare earth metal catalysts are used as hydrogen storage materials (the “Direktsynthese von Ti-dotierten Alkalimetallalanaten”, B. Bogdanović, M. Schwickardi, Appl. Phys. A (2001) 221).

It has now surprisingly been found that the properties of the specified materials as hydrogen storage materials can be improved further to a significant extent when the catalysts used for doping, namely transition metals of groups 3, 4, 5, 6, 7, 8, 9, 10, 11 or alloys or mixtures of these metals with one another or with aluminum, or compounds of these metals, in the form of very small particles which are very finely divided (e.g. particle sizes of from about 0.5 to 1000 nm) or have large specific surface areas (e.g. from 50 to 1000 m²/g) are used. The improvements in the storage properties relate to

an increase in the reversible hydrogen storage capacities up to almost the theoretical storage capacity limit of NaAlH₄ (5.5% by weight of H₂, eq. 1);

a several-fold acceleration of the hydrogen loading and discharge processes;

maintenance of the cycle stability.

The abovementioned properties are of critical importance for the prospective applications of these materials, e.g. as hydrogen stores for supplying fuel cells with hydrogen.

In particular, titanium, iron, cobalt and nickel have been found to be suitable transition metals, for example in the form of titanium, titanium-iron and titanium-aluminum catalysts. The metals titanium, iron and aluminum can be used in elemental form, in the form of Ti—Fe or Ti—Al alloys or in the form of their compounds for doping. Metal compounds which are suitable for this purpose are, for example, hydrides, carbides, nitrides, oxides, fluorides and alkoxides of titanium, iron and aluminum. Suitable dopants are, for example, titanium nitride having a specific surface area of from 50 to 200 m²/g or titanium or titanium-iron nanoparticles. The fine division or large specific surface area of the dopants can be achieved, in particular, by:

preparation of dopants using methods which lead to dopants in very finely divided form;

milling the dopant, either alone or together with the alkali metal alanates or sodium hydride/aluminum mixtures to be doped; this achieves particularly intimate intermingling of the storage material with the dopant;

milling of sodium hydride/aluminum mixtures with the dopant in the presence of hydrogen;

combinations of the methods mentioned.

Alkali metal and aluminum are preferably present in the storage materials in a molar ratio of from 3.5:1 to 1:1.5, and the catalysts used for doping are present in amounts of from 0.2 to 10 mol % based on the alkali metal alanates, particularly preferably in amounts of from 1 to 5 mol %. An excess of aluminum based on the formula I is advantageous.

The novel storage materials enable hydrogenation to be carried out at pressures of from 0.5 to 15 MPascal (5 to 150 bar) and at temperatures of from 20 to 200° C, and dehydrogenation to be carried out at temperatures of from 20 to 250° C.

To aid understanding of the invention, the following examples may be mentioned:

sodium alanate (Example 1a) doped by milling with conventional, technical-grade titanium nitride (TiN) having a specific surface area of 2 m²/g provides only 0.5% by weight of hydrogen after one dehydrogenation-rehydrogenation cycle. In contrast, if (Example 1) sodium alanate is milled in the same way with a titanium nitride having a specific surface area of 150 m2 /g and a particle size in the nanometer range (according to TEM), this gives a storage material which in a cycle test (Table 1) has a reversible storage capacity of up to 5% by weight of H₂. Comparably high reversible hydrogen storage capacities (4.9% by weight, Example 2) are also displayed by NaAlH₄ which has been doped with colloidal titanium nanoparticles (H. Bönnemann et al., J. Am. Chem. Soc. 118 (1996) 12090).

TABLE 1
Cycle test carried out on a 2.0 g sample of NaAlH₄
doped by milling (3 h) with 2 mol % of TiN having a
large specific surface area (Example 1)

| | | Dehydrogenation^{b)} | |
|---|---|---|---|
| | | conditions^{a)} | % by weight |
| Cycle | Hydrogenation No. (° C./bar) | [° C.] | of H₂ |
| 1 | — | 120/180 | 5.4 |
| 2 | A(104/140-115) | 120/180 | 5.0 |
| 3 | A(104/140-115) | 120/180 | 5.0 |
| 4 | B(170/136-122) | 120/180 | 5.1 |
| 5 | B(170/136-122) | 120/180 | 5.0 |
| 6 | B(170/136-122) | 80/120/150 | 4.7 |
| 7 | B(170/136-122) | 120 | 3.3 |
| 8 | C(120/49-37) | 120 | 2.7 |
| 9 | C(100/49-37) | 120 | 2.7 |
| 10 | C(80/49-39) | 120/180 | 4.0 |
| 11 | B(170/136-122) | 120/180 | 5.0 |
| 12 | C(120/49-37) | 120/180 | 3.1 |
| 13 | C(100/49-35) | 120/180 | 3.5 |
| 14 | C(80/49-38) | 120/180 | 2.4 |
| 15 | B(170/132-117) | 120/180 | 4.9 |
| 16 | B(170/132-117) | 120/180 | 4.9 |
| 17 | B(170/132-117) | 120/180 | 5.0 |

^{a)}The sample is exposed at 60° C. to 134(A), 130(B) or 49(C) bar of H₂ and heated at 20° C./min to the temperature indicated. Hydrogen uptake commences during the heating phase.
^{b)}At atmospheric pressure; heating rate: 4° C./min.

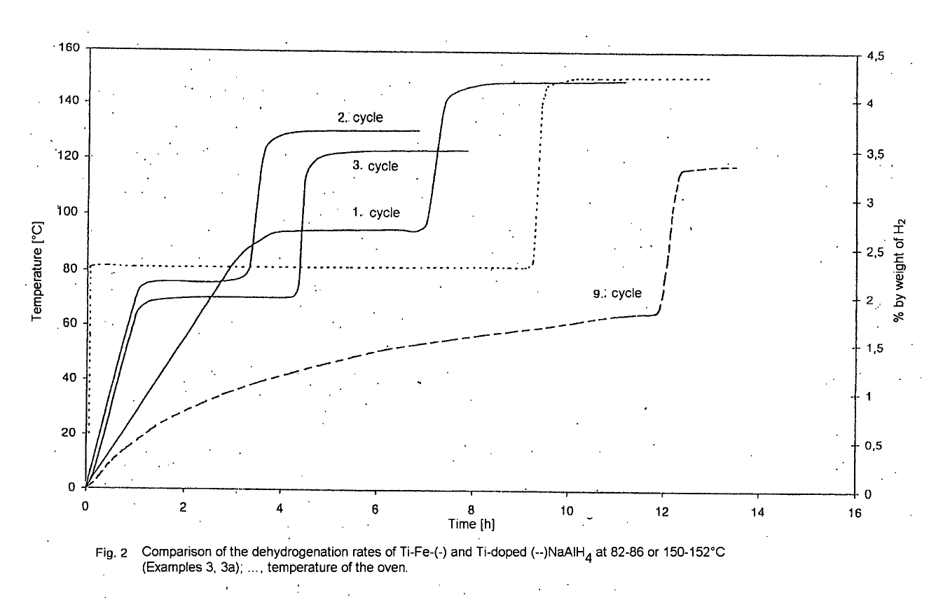

Furthermore, it has surprisingly been found that the rate of hydrogen loading and discharge of the reversible alanate systems can be increased several-fold by doping them with finely divided titanium-iron catalysts in place of titanium catalysts of this type. Thus, for example, the hydrogenation of dehydrogenated sodium alanate which has been milled with 2 mol % of titanium tetrabutoxide (Ti(OBuⁿ)₄) takes about 15 hours at 115-105° C./134-118 bar (Example 3a, FIG. 2). However, if (Example 3) sodium alanate is doped in the same way with 2 mol % of Ti(OBuⁿ)₄ and 2 mol % of iron ethoxide (Fe(OEt)₂) (“Ti—Fe combination”), the hydrogenation is finished after about 15 minutes under the same conditions (FIG. 2). The hydrogenation time is thus shortened by a factor of >60.

An important criterion for the industrial utility of metal hydrides as hydrogen storage materials is the hydrogen pressure necessary for loading a metal hydride. A reduction in the hydrogen loading pressure leads from many points of view to an improvement in the technical properties of a metal hydride hydrogen store:

a reduction in the hydrogen loading pressure considerably increases safety in handling hydrogen;

it leads to a reduction in the necessary wall thickness of the material for the hydrogen containers and thus also to a lowering of the material and production costs for such containers;

the reduction in the weight of the hydrogen container leads to an increase in the weight-based hydrogen storage capacity of the hydrogen store, which in the case of hydrogen-operated vehicles increases the range of the vehicles;

the reduction in the hydrogen loading pressure also leads to a saving of energy in the loading of the metal hydride hydrogen store with hydrogen.

As is shown by a cycle test carried out on Ti—Fe-doped NaAlH₄ (Example 3, Table 3), the hydrogen loading pressure can be reduced from, for example, 13.6-13.1 MPascal (136-131 bar) (cycle 6) to 5.7-4.4 MPascal (57-44 bar) (cycle 17) without a significant drop in the storage capacity.

The definitive criteria for assessing the suitability of metal hydrides for hydrogen storage purposes also include the hydrogen desorption temperature. This applies particularly to those applications in which the heat produced by the hydrogen-consuming apparatus (four-stroke engine, fuel cell) is to be utilized for desorption of hydrogen from the hydride. In general, it is desirable to have a very low hydrogen desorption temperature combined with a very high desorption rate of hydrogen.

The desorption of hydrogen from the doped sodium alanate occurs in two stages (Eq. 1a and b) which differ from one another in their significantly different desorption temperatures. At the lower desorption temperature (Eq. 1a), a maximum of 3.7% by weight of H₂ are released and at the higher temperature (Eq. 1b) a maximum of 1.8% by weight of H₂ are released.

NaAlH₄→1/3 Na₃AlH₆+2/3 Al+H₂ (3.7% by weight H₂) (1a)

1/3 Na₃AlH₆+2/3 Al→NaH+Al+1/2 H₂ (1.8% by weight H₂) (1b)

NaAlH₄→NaH+Al+3/2 H₂ (5.5% by weight H₂) (1)

As Example 3a (FIG. 2) shows, hydrogen can be desorbed from the Ti-doped alanate at atmospheric pressure up to the first stage (Eq. 1a) at ≧80-85° C. and up to the second stage (Eq. 1b) at ≧130-150° C. This distinguishes the Ti-doped alanate systems as reversible hydrogen storage materials from the reversible light metal hydrides based on Mg whose hydrogen desorption temperatures at atmospheric pressure are above 250-300° C.

Furthermore, it has been found that at desorption temperatures of ≧80 and ≧130° C the desorption rate of hydrogen can be increased considerably, and the desorption time can thus be shortened, by doping the NaAlH₄ according to the present invention with Ti—Fe combinations instead of with Ti alone. Thus, for example (Example 3a, FIG. 2), dehydrogenation of the NaAlH₄ doped with Ti(OBuⁿ)₄ (2 mol %) by grinding takes a total of 12½ hours at 80-82 and 150-152° C. In contrast, if NaAlH₄ (Example 3, FIG. 2) is doped in the same way with a combination of 2 mol % of Ti(OBuⁿ)₄ and 2 mol % of Fe(OC₂H₅), the dehydrogenation of the first stage (84-86° C.) is complete after about one hour and that in the second stage (150-152° C. is complete after 15-20 minutes.

In the direct synthesis of Ti-doped sodium alanates (p. 1), sodium hydride/aluminum powder mixtures are reacted with hydrogen in accordance with Eq. 2 in the presence of the dopant.

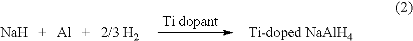

As Example 4 shows, reversible hydrogen storage capacities of 4.6% of H₂ are achieved even after 2 cycles when using titanium metal nanoparticles as dopant in the direct synthesis, which constitutes a considerable improvement over the previous process (SGK, PCT/EP01/02363). Both when using doped sodium alanates as reversible hydrogen stores and when using those which have been obtained by direct synthesis, aluminum can, if appropriate, be used in superstoichiometric or substoichiometric amounts based on Eq. 1 or 2.

The invention is illustrated by the following Examples without being restricted thereto. All experiments using air-sensitive materials were carried out in a protective atmosphere, e.g. argon.

### EXAMPLE 1

### (NaAlH₄ Doped with Titanium Nitride Having a Large Specific Surface Area as Reversible Hydrogen Store)

To prepare the titanium nitride (TiN) having a large specific surface area, the following method was employed: 27.0 g (15.6 ml, 0.14 mol) of TiCl₄ (Aldrich 99.9%) were dissolved in 700 ml of pentane and, at room temperature (RT), a mixture of 35 ml (0.43 mol) of THF and 60 ml of pentane were added dropwise to the solution while stirring. After stirring for 5 hours at RT, the yellow precipitate was filtered off, washed twice with 50 ml of pentane and dried under reduced pressure (10⁻³ mbar). This gave 45.5 g (96%) of TiCl₄.2THF as a lemon yellow solid. 2.46 g thereof were weighed into a porcelain boat in a glove box and heated in a stream of NH₃ (20-25 ml/min) in a fused silica tube located in a tube furnace at 10° C./min to 700° C and maintained at this temperature for 1 hour in the NH₃ stream. The white NH₄Cl sublimate was collected in a cold trap. The fused silica tube was allowed to cool to 120° C. in the NH3 stream, and the tube was subsequently flushed with argon for 5 minutes and the apparatus was cooled to RT. The TiN in the fused silica tube was dried at 10⁻mbar and transferred to a Schlenk vessel in the glove box. 0.34 g of TiN were obtained as a loose, black powder. Elemental analysis: Ti 60.13, N 13.76, C 12.86, H 1.24, Cl<1%. Determination of the specific surface area by the BET method on a 0.17 g sample of the TiN gave a value of 152.4 m²/g. The isotherm shape indicates the presence of nanoparticles. The XRD pattern (as film) showed 3 broad reflections which can be assigned to TiN. The width of the reflections indicates a particle size in the nanometer range.

4.00 g (74.1 mmol) of NaAlH₄ which had been purified by crystallization in accordance with J. Alloys Comp. 302, (2000) 36, and 0.092 g (1.48 mmol; 1.6 mol % based on NaAlH₄) of the TiN were stirred together in a glove box and milled for 3 hours in a Spex vibratory mill (milling container made of steel, 61 ml; 2 steel balls each weighing 8.4 g and having a diameter of 13 mm) for the purpose of doping. A sample (2.00 g) of the NaAlH₄ which had been doped in this way with TiN was subjected to a dehydrogenation/rehydrogenation test lasting for 17 cycles, with the cycling conditions being varied. The cycle test was carried out using the apparatus described and depicted in J. Alloys Comp. 253-254 (1997) 1 (Autoclave Volume: ˜40 ml). The results of the cycle test are given in Table 1. As can be seen from Table 1, reversible hydrogen storage capacities of 4.9-5.0% by weight (91-93% of theory) were achieved under the hydrogenation conditions A and B (cycles No. 2-6, 11, 15-17). In cycle No. 7, the dehydrogenation was carried out only to the first dissociation stage (Eq. 1a) by maintaining a desorption temperature of 120° C.; in this cycle, the sample released 3.3% by weight of hydrogen (89% of theory).

### EXAMPLE 1a

### Comparative Example

In a comparative example, NaAlH₄ is doped in the same way as in Example 1, but with 2 mol % of a commercial TiN (from Aldrich, specific surface area: 2 m²/g). In the first thermolysis (up to 180° C., 4.3% by weight of H₂ were desorbed. After rehydrogenation (100° C./100 bar/12 h), the sample released only 0.5% by weight of H₂ over a period of 3 hours on dehydrogenation at 180° C.

### EXAMPLE 2

### (NaAlH₄ Doped with Ti Nanoparticles as Reversible Hydrogen Store)

1.0 g (18.5 mmol) of the NaAlH₄ purified by crystallization (e.g. Example 1) and 44 mg of colloidal titanium Ti⁰-0.5 THF prepared in the form of nanoparticles (≦0.8 nm) (H. Bönnemann et al., J. Am. Chem. Soc. 118 (1996) 12090; the sample contains about 40% by weight of Ti, corresponding to ˜2 mol % of Ti based on NaAlH₄, balance: tetrahydrofuran, KBr) were stirred with one another in a glove box and subsequently milled in a Spex vibratory mill (cf. Example 1) for 3 hours. A sample (˜1 g) of the NaAlH₄ milled with Ti nanoparticles was subjected to a cycle test (Table 2).

TABLE 2

| | | Dehydrogenation | % by |
|---|---|---|---|
| Cycle | Hydrogenation | [° C.]^{a)} | weight of H₂ |
| 1 | — | 120/180 | 5.25 |
| 2 | 100° C./100-125 bar/12 h^{b)} | 120/180 | 4.9 |
| 3 | 100° C./100-125 bar/12 h^{b)} | 120/180 | 4.9 |
| 4 | 100° C./100-125 bar/12 h^{b)} | 120/180 | 4.9 |

^{a}At temperatures of 120 and subsequently 180° C. (heating rate: 4° C./min), dehydrogenation at atmospheric pressure proceeds to the 1^{st} and 2^{nd} dissociation stages of the Ti-doped NaAlH₄. The dehydrogenation in the 1^{st} dissociation stage was concluded after ˜1 h and that in the 2^{nd} stage was concluded after ˜½ h.
^{b}The sample is exposed to 100 bar of hydrogen at room temperature in a 200 ml autoclave, and the autoclave is subsequently maintained at 100° C. for 12 hours.

### EXAMPLE 2a

### Comparative Example

The experiment was carried out in a manner analogous to Example 2 using commercial titanium powder (325 mesh) for doping the NaAlH₄. In the first dehydrogenation, a sample (˜1.1 g) released 3.6% by weight of H₂ over a period of 8 hours at 160° C.

### EXAMPLE 3

### (NaAlH₄ Doped by Milling with 2 mol % of Ti(OBuⁿ)₄ and 2 mol % of Fe(OEt)₂ as Reversible Hydrogen Store)

Caution: The NaAlH₄ doped with Ti(OBuⁿ)₄ and Fe(OEt)₂ can in the milled state decompose explosively on exposure to air. Care is therefore necessary when handling this material!

1.50 g (27.8 mmol) of the purified (cf. Example 1) NaAlH₄ and 81 mg (0.56 mmol) of Fe(OEt)₂ (prepared in accordance with Liebigs Ann. Chem. (1975) 672) were weighed into a 10 ml steel milling container in a glove box, stirred together and then admixed with 0.2 ml (0.56 mmol) of Ti(OBuⁿ)₄ from a syringe. The milling vessel was provided with 2 steel balls (6.97 g, 12 mm diameter) and the mixture subsequently milled in a vibratory mill (from Retsch, MM 200, Haan, Germany) at 30 s⁻¹ for 3 hours. After the milling process was complete, the milling vessel was hot and the originally colorless mixture was dark brown.

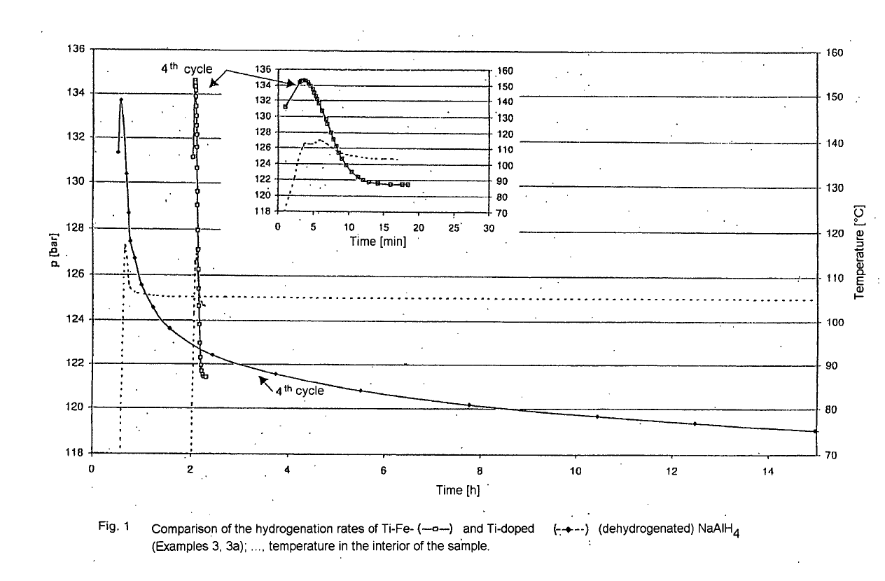

The preparation of the Ti—Fe-doped NaAlH₄ was repeated in the same way as described above using 1.70 g of NaAlH₄ as starting material. A mixed sample (1.72 g) of the Ti—Fe-doped alanate from two batches was subjected to a cycle test for 17 cycles (cf. Example 1). Table 3 shows the data from the cycle test carried out. Comparison of the hydrogenation rates of the Ti—Fe-doped NaAlH₄ and a corresponding Ti-doped sample (Example 3a) at 104° C./134-135 bar is given in FIG. 1.

TABLE 3
Cycle test carried out on a 1.72 g sample of NaAlH₄
doped by milling (3 h) with 2 mol % of Ti(OBu)₄ and
2 mol % of Fe(OEt)₂ (Example 3)

| | Hydrogenation^{a)} | Dehydrogenation^{b)} | H₂ [% by weight] |
|---|---|---|---|
| Cycle No. | (° C./bar) | [° C.] | 1^{st}/1^{st} + 2^{nd} stage |
| 1 | — | 80/150 | 2.6/4.3 |
| 2 | A(104/135-119) | 80/150 | 2.3/3.8 |
| 3 | A(104/135-120) | 80/150 | 2.2/3.7 |
| 4 | A(104/135-120) | 30/80/150 | /3.2 |
| 5 | B(150/135-128) | 80/140 | 2.0/3.5 |
| 6 | B(160/136-131) | 80/130 | 2.0/3.3 |
| 7 | C(120/48-43) | 80/130 | /1.6 |
| 8 | C(120/n.b.^{c)} | 120/180 | |
| 9 | C(120/48-43) | 120/180 | ˜0/1.6 |
| 10 | C(120/48-43) | 120/180 | ˜0/1.5 |
| 11 | B(160/138-135) | 120/180 | 1.8/3.3 |
| 12 | C(120/49-42) | 120/180 | 0.3/1.8 |
| 13 | C(100/49-42) | 120/180 | ˜0/1.4 |
| 14 | C(100/49-42) | 120/180 | ˜0/1.4 |
| 15 | (100/73-59)^{d)} | 120/180 | 1.5/3.0 |
| 16 | (100/62-49)^{e)} | 120/180 | 1.5/2.9 |
| 17 | (100/57-44)^{f)} | 120/180 | 1.6/3.1 |

^{a)}The sample is exposed at 60° C. to 134 (A), 130 (B) or 49 (C) bar of H₂ and heated at 20° C./min to the temperature indicated. Hydrogen uptake begins during the heating phase.
^{b)}At atmospheric pressure; heating rate: 4° C./min.
^{c)}Not determined.
^{d)}Initial pressure: 70 bar at 60° C.
^{e)}Initial pressure: 60 bar at 60° C.
^{f)}Initial pressure: 55 bar at 60° C.

A sample of 0.8 g of the Ti—Fe-doped alanate from the first batch was subjected to 3 dehydrogenation-rehydrogenation cycles (Table 4 and FIG. 2). During the dehydrogenations, the temperature was firstly increased to 84-86 and subsequently to 150-152° C. to bring about the dehydrogenations to the first dissociation stage (Eq. 1a) and second dissociation stage (Eq. 1b). After each dehydrogenation, the sample was rehydrogenated at 100° C./10 MPascal (100 bar)/12 h. As FIG. 2 shows, the dehydrogenations in the 1^{st} and 2^{nd} stages proceed at virtually constant rates; the 2^{nd} dehydrogenation is faster than the 1^{st} and occurs at the same rate as the 3^{rd} dehydrogenation. In cycles 2 and 3, the dehydrogenation in the 1^{st} stage is complete after ˜1 hour and that in the 2^{nd} stage is complete after 20-30 minutes. For comparison, FIG. 2 also shows the dehydrogenation of a corresponding Ti-doped sample (Example 3a).

TABLE 4

| | | Dehydrogenation | % by weight |
|---|---|---|---|
| | | [° C.]^{a)} | of H₂ |
| Cycle | Hydrogenation | 1^{st}/2^{nd} stage | 1^{st}/1^{st} + 2^{nd} stage |
| 1 | — | 84-86/150-152 | 2.7/4.2 |
| 2 | 100° C./100 bar/12 h^{b)} | 84-86/150-152 | 2.2/3.7 |
| 3 | 100° C./100 bar/12 h^{b)} | 84-86/150-152 | 2.0/3.5 |

^{a}Dehydrogenation to the 1^{st} and 2^{nd} dissociation stages of the doped NaAlH₄; the courses of the dehydrogenations are shown in FIG. 2.

### EXAMPLE 3a

### Comparative Example

In the comparative example, NaAlH₄ was doped in the same way as in Example 3, but using Ti(OBuⁿ)₄. The hydrogenation and dehydrogenation behavior of the sample of the Ti-doped alanate compared to that of the Ti-Fe-doped sample is shown in FIG. 1 and 2, respectively.

### EXAMPLE 4

### Direct Synthesis of Ti-doped NaAlH₄ from NaH, Al powder and Ti Nanoparticles

The experiment was carried out in a manner analogous to Example 2, but starting from 0.70 g (29.2 mmol) of NaH, 0.79 g of Al powder (Aluminiumhütte Rheinfelden, particle size <60 μ; 93% pure, based on the amount of hydrogen evolved on hydrolysis with dilute H₂SO₄; 27.2 mmol of Al) and 0.069 g of the titanium nanoparticles Ti⁰.0.5 THF (0.58 mmol of Ti). After milling for 3 hours, the black solid (1.50 g) was subjected to 3 hydrogenation-dehydrogenation cycles (Table 5). As the table shows, a hydrogen storage capacity of 3.9% by weight is achieved after the first hydrogenation and a capacity of 4.6% by weight is achieved after the second hydrogenation.

TABLE 5

| | Hydrogenation^{a)} | Dehydrogenation | % by weight of H₂ |
|---|---|---|---|
| Cycle | [° C./bar/h] | [° C.]^{b,c)} | 1^{St} stage/1^{st} + 2^{nd} stage |
| 1 | 100/100/12 | 120/180 | 2.2/3.9 |
| 2 | 140/90/12 | 120/180 | 2.9/4.6 |
| 3 | 150/90/12 | 120/180 | 2.8/4.4 |

^{a)}The sample is exposed to 10 or 9 MPascal (100 or 90 bar) of hydrogen at room temperature in a 200 ml autoclave and the autoclave is subsequently maintained at the temperature indicated for 12 hours.
^{b)}At temperatures of 120 and subsequently 180° C., the dehydrogenation proceeds to the 1^{st} and 2^{nd} dissociation stages of the Ti-doped NaAlH₄ at atmospheric pressure.
^{c)}dehydrogenation times: ˜1 h at 120° C. and ˜2 h at 180° C.

### EXAMPLE 5

### Demonstration of the Cycle Stability

A 2 g sample of the NaAlH₄ doped (as in Example 2) with 2.0 mol % of colloidal titanium was subjected to a hydrogen discharge and loading test lasting for 25 cycles. Cycle test conditions: dehydrogenation, 120/180° C., atmospheric pressure; hydrogenation: 100° C./100-85 bar. After the first cycles 2-5, giving a storage capacity of 4.8% by weight of H₂, the capacity remained constant at 4.5-4.6% by weight of H₂ to the end of the test.

1. A hydrogen storage material comprising alkali metal aluminum hydrides (alkali metal alanates) of the general formula 1,
M¹_{P(1-x)}M²ₚₓAlH₃₊ₚ
M¹=Na, K; M²=Li, K
0≦x≦˜0.8; 1≦p≦3 (1)
or mixtures of aluminum metal with alkali metals and/or alkali metal hydrides which have been doped with metal catalysts, the metal catalysts being transition metals of groups 3-11 of the Periodic Table of the Elements or alloys or mixtures of these metals, or compounds of these metals, characterized in that the metal catalysts are nanoparticles which are very finely divided or have a large specific surface area.

2. A hydrogen storage material as claimed in claim 1, wherein titanium, iron, cobalt or nickel are used as metals of groups 3-11.

3. A hydrogen storage material as claimed in claim 1, wherein titanium, titanium-iron or titanium-aluminum catalysts are used as metal catalysts.

4. A hydrogen storage material as claimed in claims 14, wherein the catalysts used for doping have particle sizes of from −0.5 to 1000 nm.

5. A hydrogen storage material as claimed in claim 1, wherein the catalysts used for doping have specific surface areas of from 50 to 1000 m²/g.

6. A hydrogen storage material as claimed in claim 1, which has been doped with titanium, iron or aluminum in elemental form.

7. A hydrogen storage material as claimed in claim 1, which has been doped with titanium, iron or aluminum in the form of their alloys.

8. A hydrogen storage material as claimed in claim 1, which has been doped with titanium, iron or aluminum in the form of their compounds.

9. A hydrogen storage material as claimed in claim 8, which has been doped with titanium, iron or aluminum in the form of their hydrides, carbides, nitrides, oxides, fluorides or alkoxides.

10. A hydrogen storage material as claimed in claim 9, which has been doped with titanium nitride (TiN) having a specific surface area of 50-200 m²/g.

11. A hydrogen storage material as claimed in claim 1, which has been doped with titanium metal nanoparticles.

12. A hydrogen storage material as claimed in claim 1, which has been doped with titanium-iron nanoparticles.

13. A hydrogen storage material as claimed in claim 1, wherein aluminum is present in super stoichiometric amounts based on the formula 1.

14. A hydrogen storage material as claimed in claim 1, wherein the molar ratio of alkali metal to aluminum is from 3.5:1 to 1:1.5.

15. A hydrogen storage material as claimed in claim 1, wherein the catalysts used for doping are present in amounts of from 0.2 to 10 mol % based on alkali metal alanates of the formula 1.

16. A hydrogen storage material as claimed in claim 15, wherein the catalysts used for doping are present in amounts of from 1 to 5 mol % based on alkali metal alanates of the formula 1.

17. A hydrogen storage material as claimed in claim 1, wherein catalysts used for doping have been milled either alone or together with the alkali metal alanates to be doped or the mixtures to be doped.

18. A method of reversibly storing hydrogen, wherein hydrogen storage materials as claimed in claim 1 are used for the uptake of hydrogen and are recovered after subsequent dehydrogenation.

19. The method as claimed in claim 18, wherein the hydrogenation is carried out at pressures of from 5 to 150 bar and temperatures of from 20 to 200° C.

20. The method as claimed in claim 18, wherein the dehydrogenation is carried out at temperatures of from 20 to 250° C.
